(19) United States
(12) Patent Application Publication
(10) Pub. No.: US 2008/0012356 A1
(43) Pub. Date: Jan. 17, 2008

(54) Apparatus for assisting in opening and closing the door Latch on a trailer of a tractor trailer combination

(76) Inventor: Milagros Lugo, Hollywood, FL (US)

Correspondence Address: JAMES RAY & ASSOCIATES, 2640 PITCAIRN ROAD, MONROEVILLE, PA, 15146, US

(21) Appl. No.: 11/472,968

(22) Filed: Jun. 22, 2006

(51) Int. Cl. E05C 3/04

(52) U.S. Cl. 292/218

(57) ABSTRACT

An apparatus for assisting in at least one of opening and closing a door latch attached to at least one door of a trailer. The apparatus includes an elongated tubular type member having each of a first predetermined length and a first predetermined shape. There is an offset portion having a second predetermined length and a second predetermined shape connected at a first end thereof to a predetermined end of such elongated tubular type member. An oval shaped substantially hollow portion having a third predetermined length is connected at a first end thereof to a second end of the offset portion for receiving an end of such door latch at a second end thereof.

### FIELD OF THE INVENTION

The present invention relates, in general, to door latches used to hold the doors of a trailer on a tractor trailer combination in a closed and locked position and, more particularly, this invention relates to an apparatus to assist a driver and/or driver's helper in opening and closing such door latch disposed on such trailer.

### BACKGROUND OF THE INVENTION

Prior to the conception and development of the present invention, as is generally well known in the prior art, the trailer portion of a tractor trailer includes at least one door which must be closed and maintained in a relatively secure manner. The door locks on these trailers will normally have a very tight fit to prevent unintentional and/or accidental opening.

This is especially the case on newer doors which have not yet had any material removed by frictional erosion from opening and closing the door latch. This then can cause a problem in opening the locking mechanism and oftentimes will result in either a hand or finger injury to drivers and others required to open these doors.

This is particularly the situation in the case of female drivers or workers who may not be as strong as their male counterparts.

Another reason these door latches are rather difficult to open is that the clearance between the latch and the face of the door is rather close which can limit the possible leverage required to open the latch.

### SUMMARY OF THE INVENTION

The present invention provides an apparatus for assisting in opening and closing the door latch on a trailer of a tractor trailer combination. Such apparatus includes an elongated tubular type member having each of a first predetermined length and a predetermined shape. An offset portion having a second predetermined length and a second predetermined shape is connected at a first end thereof to a predetermined end of such elongated tubular type member. There is an oval shaped substantially hollow portion having a third predetermined length connected at a first end thereof to a second end of the offset portion for receiving an end of such door latch at a second end thereof. Each of the elongated tubular type member and such offset portion and such oval shaped substantially hollow portion are formed from a predetermined material.

### OBJECTS OF THE INVENTION

It is therefore one of the primary objects of the present invention to provide an apparatus which will assist in opening and closing the door latch on a trailer that is light weight.

Another object of the present invention is to provide an apparatus which will assist in opening and closing the door latch on a trailer which is easy to use.

Still another object of the present invention is to provide an apparatus which will assist in opening and closing the door latch on a trailer which will minimize injuries to personnel.

Yet another object of the present invention is to provide an apparatus which will assist in opening and closing the door latch on a trailer which can be manufactured from a variety of materials.

A further object of the present invention is to provide an apparatus which will assist in opening and closing the door latch on a trailer which can be manufactured in a number of different shapes.

It is an additional object of the present invention to provide an apparatus which will assist in opening and closing the door latch on a trailer which is portable.

Still yet another object of the present invention is to provide an apparatus which will assist in opening and closing the door latch on a trailer which can also be used for other functions required by driver's to perform.

A still further object of the present invention is to provide an apparatus which will assist in opening and closing the door latch on a trailer which is useful in breaking seals.

An additional object of the present invention is to provide an apparatus which will assist in opening and closing the door latch on a trailer which can be manufactured from a variety of materials.

In addition to the numerous objects and advantages of the present invention which have been described in considerable detail above, it should be noted that various other objects and advantages of the instant invention will become more readily apparent to those persons who are skilled in the relevant art from the following more detailed description of the invention, particularly, when such description is taken in conjunction with the attached drawing Figures and with the appended claims.

### BRIEF DESCRIPTION OF THE DRAWINGS

FIG. 1 is a front view illustrating the presently preferred embodiment of the apparatus to assist in one of opening and closing a door latch on a trailer connected to such door latch;

FIG. 2 is a view illustrating the end portion of the apparatus illustrated in FIG. 1; and

FIG. 3 is a side elevation view of the apparatus illustrated in FIGS. 1 and 2.

### BRIEF DESCRIPTION OF A PRESENTLY

### PREFERRED AND VARIOUS ALTERNATIVE

### EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing Figures.

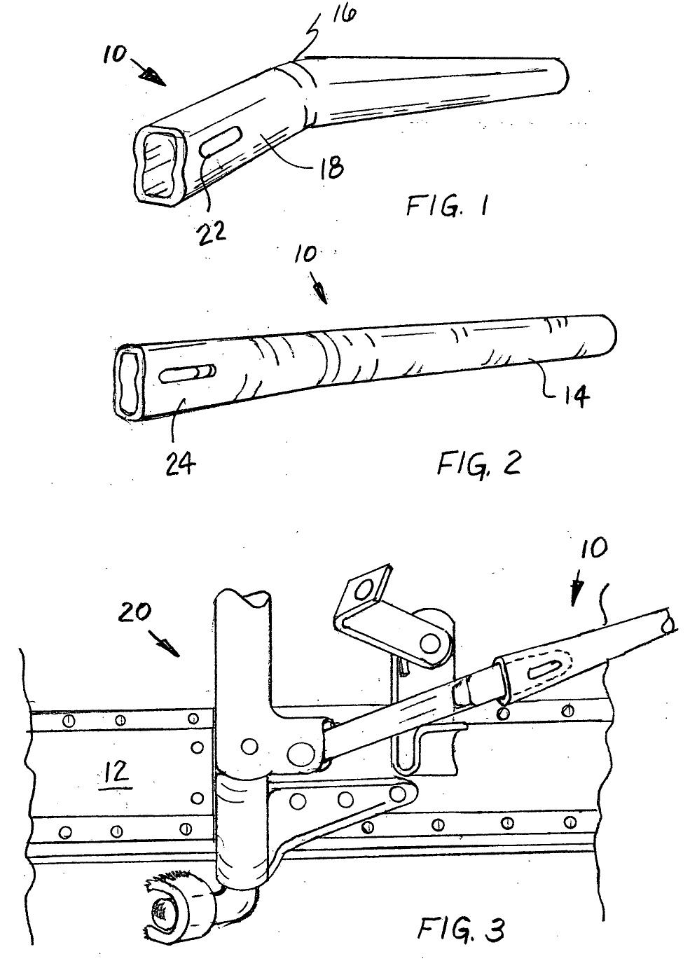

Now refer more particularly to FIGS. 1-3. Illustrated therein is a presently preferred embodiment of an apparatus, generally designated 10, for assisting in opening and closing the door latch, generally designated 20, connected to a pair of doors 12 of a trailer portion (not shown) of a tractor trailer combination (not shown).

Apparatus 10 includes an elongated tubular type member 14 having each of a first predetermined length and a first predetermined shape. In the presently preferred embodiment of the invention, the first predetermined shape of such elongated tubular type member is generally cylindrical.

Further apparatus 10 includes an offset portion 16 having each of a second predetermined length and a second predetermined shape connected at a first end thereof to a predetermined end of the elongated tubular type member 14. As with the first predetermined shape of such elongated tubular type member 14 it is presently preferred that the second predetermined shape of such offset portion 16 is generally cylindrical.

There is additionally an oval shaped substantially hollow portion 18 having a third predetermined length connected at a first end thereof to a second end of such offset portion 16 for receiving an end of such door latch 20 at a second end thereof. In the presently preferred embodiment of the invention oval shaped substantially hollow portion 18 includes at least one aperture 22 formed through a side wall portion 24 thereof closely adjacent such second end thereof to enable hanging such apparatus 10 on a hook (not shown) when not in use.

It should be understood that each of the elongated tubular type member 14, the offset portion 16 and the oval shaped substantially hollow portion 18 are all formed from a predetermined material. Preferably, such predetermined material will be the same for each such elongated tubular type member 14, offset portion 16 and the oval shaped substantially hollow portion 18. Additionally, it is presently preferred that this predetermined material is selected from the group consisting of aluminum and steel with the preferred predetermined material being steel.

According to the preferred embodiment of the invention, the first predetermined length of elongated tubular type member 14 will be greater than each of such second predetermined length of the offset portion 16 and the third predetermined length of such oval shaped substantially hollow portion 18. Furthermore, the third predetermined length of such oval shaped substantially hollow portion 18 will be greater than such second predetermined length of offset portion 16.

Although it is within the scope of the present invention for the apparatus 10 to be formed from a plurality of pieces, it is presently preferred that apparatus 10 will be formed from a single piece.

While in accordance with the patent statutes both a presently preferred and various alternative embodiments of the invention have been described in sufficient detail to enable a person skilled in the relevant art to make and use the same it should be understood that other modifications and adaptations of the invention can be made without departing from the spirit of the invention or the scope of the appended claims.

I claim:

1. An apparatus for assisting in at least one of opening and closing a door latch attached to at least one door of a trailer, said apparatus comprising:
(a) an elongated tubular type member having each of a first predetermined length and a first predetermined shape;
(b) an offset portion having a second predetermined length and a second predetermined shape connected at a first end thereof to a predetermined end of said elongated tubular type member;
(c) an oval shaped substantially hollow portion having a third predetermined length connected at a first end thereof to a second end of said offset portion for receiving an end of said door latch at a second end thereof; and
(d) each of said elongated tubular type member and said offset portion and said oval shaped substantially hollow portion are formed from a predetermined material.

2. An apparatus, according to claim 1, wherein said first predetermined length of said elongated tubular type member is greater than each of said second predetermined length of said offset portion and said third predetermined length of said oval shaped substantially hollow portion.

3. An apparatus, according to claim 1, wherein said third predetermined length of said oval shaped substantially hollow portion is greater than said second predetermined length of said offset portion.

4. An apparatus, according to claim 1, wherein said first predetermined shape of said elongated tubular type member is generally cylindrical.

5. An apparatus, according to claim 4, wherein said second predetermined shape of said offset portion is generally cylindrical.

6. An apparatus, according to claim 1, wherein said oval shaped substantially hollow portion includes at least one aperture formed through a side wall portion thereof closely adjacent said second end thereof to enable hanging said apparatus on a hook when not in use.

7. An apparatus, according to claim 1, wherein said predetermined material is selected from the group consisting of aluminum and steel.

8. An apparatus, according to claim 7, wherein said predetermined material is steel.

9. An apparatus, according to claim 1, wherein said apparatus is formed from a plurality of pieces.

10. An apparatus, according to claim 1, wherein said apparatus is formed from a single piece.
